(19) United States
(12) Patent Application Publication
(10) Pub. No.: US 2018/0108302 A1
(43) Pub. Date: Apr. 19, 2018

(54) BACKLIGHT CONTROL STRUCTURE AND DISPLAY DEVICE WITH COVER WINDOW

(71) Applicant: Wuhan China Star Optoelectronics Technology Co., Ltd., Wuhan, Hubei (CN)

(72) Inventors: Xingling GUO, Shenzhen, Guangdong (CN); Chun-hung HUANG, Shenzhen, Guangdong (CN); Jiehui QIN, Shenzhen, Guangdong (US)

(73) Assignee: Wuhan China Star Optoelectronics Technology Co., Ltd., Wuhan, Hubei (CN)

(21) Appl. No.: 15/110,088

(22) PCT Filed: Jun. 7, 2016
(86) PCT No.: PCT/CN2016/085125

§ 371 Date: Jul. 6, 2016

(30) Foreign Application Priority Data
May 19, 2016 (CN) 201610333294.9

(51) Int. Cl. G09G 3/34; G09G 3/36

(52) U.S. Cl. CPC G09G 3/3406; G09G 2330/023; G09G 2360/144; G09G 3/36

(57) ABSTRACT

A backlight control structure is disclosed. The structure includes a sensor, a controller, a driving chip and a light strip electrically connected sequentially, wherein, the driving chip includes a first and a second driving unit; the light strip includes multiple backlight lamps, and a portion of the backlight lamps sequentially adjacent forms a first window light group for lighting up a first cover window display region; the photosensitive sensor senses a change of an operation environment and sends an electric signal to the controller; after the controller processes the received electric signal, the controller selectively controls operation statuses of the first and the second driving unit; the first driving unit drives all of the backlight lamps of the light strip to emit light, and the second driving unit drives the first window light group to emit light to ensure the display effect, and decrease the power consumption.

### CROSS REFERENCE

The claims of this application have submitted to the State Intellectual Property Office of the People's Republic of China (SIPO) on May 19, 2016, Application No. 201610333294.9. The priority right based on the China application has a title of “Backlight control structure and display device with cover window”. The entire contents of the above-mentioned patent application will be incorporated in the present application through citing.

### FIELD OF THE INVENTION

The present invention relates to display technology field and more particularly to a backlight control structure and a display device with cover window.

### BACKGROUND OF THE INVENTION

A device such as the cell phone and tablet is widely applied in people's life such that how to save power consumption and extend a standby time of the device becomes a primary problem for improving a user experience. The power consumption of the screen of the cell phone occupies 60%-70% of total power consumption. Because the display screen of the current cell phone is a transmissive display module without illuminating actively, the backlight module provides a backlight source through a light strip, and through controlling the rotation of the liquid crystal molecules to control a displayed image and brightness. The power consumption of the backlight module occupies 70%-80% of the power consumption of the total screen so that decreasing the unnecessary power consumption of the backlight module will greatly decrease the total power consumption of the cell phone.

In the conventional art, the display device such as the cell phone is provided with a cover having a cover window. When the cover is closed, the device displays a portion of image through the cover window. In order to display the image corresponding to the cover window, the entire light strip is lighted up such that the backlight module maintains a full bright status. Only displaying a part of the regions of the display panel to light up the entire light strip will waste most of the backlight source, waste the device power, and not meet the design requirement for low power consumption.

### SUMMARY OF THE INVENTION

Accordingly, the present invention provides a backlight control structure and a display device with cover window in order to solve the problem of wasting most of the backlight source because of displaying the image corresponding to the cover window, the entire light strip being lighted up such that the backlight module maintains a full bright status in the conventional art.

A backlight control structure, comprising a sensor, a controller, a driving chip and a light strip which are electrically connected sequentially, wherein, the driving chip includes a first driving unit and a second driving unit; the light strip includes multiple backlight lamps, and a portion of the backlight lamps which are sequentially adjacent forms a first window light group for lighting up a first cover window display region of a display device; the photosensitive sensor senses a change of an operation environment and sends an electric signal to the controller; after the controller processes the received electric signal, the controller selectively controls operation statuses of the first driving unit and the second driving unit; the first driving unit drives all of the backlight lamps of the light strip to emit light, and the second driving unit drives the first window light group to emit light.

Wherein, the driving chip includes a first driving switch and a second driving switch; the first driving switch is connected between the controller and the first driving unit; the second driving switch is connected between the controller and the second driving unit.

Wherein, the controller includes a judgment unit and a control unit; the judgment unit receives the electric signal sent by the photosensitive sensor and determines an operation status of the display device; the control unit turns on or off the first driving switch or the second driving switch according to a processing result of the judgment unit.

Wherein, the light strip further includes a second window light group formed by a portion of the backlight lamps for lighting up a second cover window display region of the display device, the second driving unit simultaneously controls the first window light group and the second window light group.

Wherein, the light strip further includes a second window light group formed by a portion of the backlight lamps for lighting up a second cover window display region of the display device; the driving chip includes a third driving unit for controlling the second window light group; the first window light group and the second window light group operate independently.

Wherein, the sensor is a photosensitive sensor.

Wherein, the first window light group is located at a terminal of the light strip.

Wherein, the controller adopts a 16-bit micro control unit.

A display device with cover window, comprising a screen cover, a display panel and a backlight module; the backlight module includes a lens sheet, a diffusion sheet, a light guide sheet, a reflective sheet and a backlight control structure; a light source generated by backlight lamps forms a backlight source after passing through the light guide sheet, the reflective sheet, the diffusion sheet and the lens sheet; the screen cover includes a transparent cover window; when the screen cover of a display device with cover window is opened up, all display regions of the display panel display an image; when the screen cover of display device with cover window is closed, a cover window display region of the display panel corresponding to the transparent cover window displays an image.

Wherein, the backlight control structure comprises a sensor, a controller, a driving chip and a light strip which are electrically connected sequentially, wherein, the driving chip includes a first driving unit and a second driving unit; the light strip includes multiple backlight lamps, and a portion of the backlight lamps which are sequentially adjacent forms a first window light group for lighting up a first cover window display region of a display device; the photosensitive sensor senses a change of an operation environment and sends an electric signal to the controller; after the controller processes the received electric signal, the controller selectively controls operation statuses of the first driving unit and the second driving unit; the first driving unit drives all of the backlight lamps of the light strip to emit light, and the second driving unit drives the first window light group to emit light.

Wherein, the driving chip includes a first driving switch and a second driving switch; the first driving switch is connected between the controller and the first driving unit; the second driving switch is connected between the controller and the second driving unit.

Wherein, the controller includes a judgment unit and a control unit; the judgment unit receives the electric signal sent by the photosensitive sensor and determines an operation status of the display device; the control unit turns on or off the first driving switch or the second driving switch according to a processing result of the judgment unit.

Wherein, the light strip further includes a second window light group formed by a portion of the backlight lamps for lighting up a second cover window display region of the display device, the second driving unit simultaneously controls the first window light group and the second window light group.

Wherein, the light strip further includes a second window light group formed by a portion of the backlight lamps for lighting up a second cover window display region of the display device; the driving chip includes a third driving unit for controlling the second window light group; the first window light group and the second window light group operate independently.

Wherein, the sensor is a photosensitive sensor.

Wherein, the first window light group is located at a terminal of the light strip.

Wherein, the controller adopts a 16-bit micro control unit.

Wherein, the backlight control structure is provided with a screen driving chip, and the screen driving chip controls image contents displayed by the display panel respectively when the screen cover is opened up and the screen cover is closed.

The beneficial effects of the present invention are as follows: the driving chip is provided with independent driving units to respectively control the backlight strip to operate totally or partially. When the screen cover is opened up, all backlight lamps is lighted up, the backlight source is fully bright, the display panel displays fully to meet the usage requirement; when the screen cover is closed, only lighting up a portion of backlight lamps to obtain a portion of the backlight source only corresponding to the cover window, the display panel only displays an image corresponding to the cover window so as to ensure the display effect, and decrease the power consumption at the same time.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic diagram of a backlight control structure provided by an embodiment of the present invention;

FIG. 2 is a structural diagram of a backlight module provided by a first embodiment of the present invention;

FIG. 3 is a structural diagram of a display device with cover window provided by the first embodiment of the present invention;

FIG. 4 is a structural diagram of a backlight module provided by a second embodiment of the present invention; and

FIG. 5 is a structural diagram of a backlight module provided by a third embodiment of the present invention.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

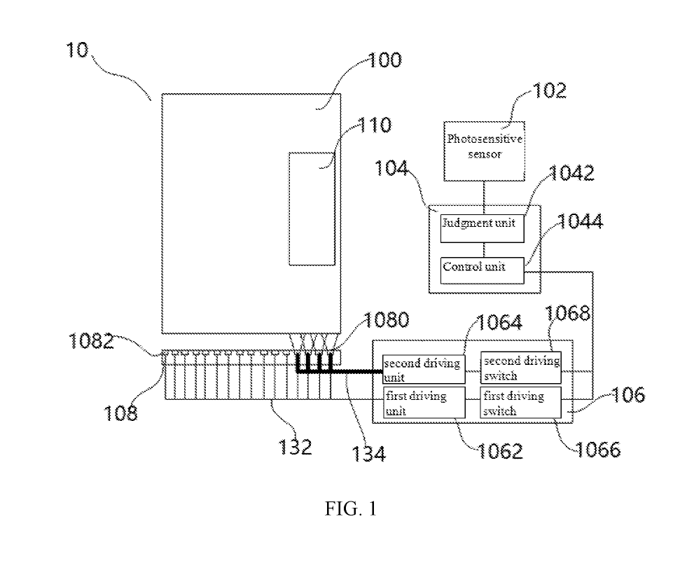

FIG. 1 is a schematic diagram of a backlight control structure provided by an embodiment of the present invention. As shown in the figure, a backlight control structure 10 includes a photosensitive sensor 102, a controller 104, a driving chip 106 and an LED light strip 108. The photosensitive sensor 102 transforms a light signal into an electric signal through sensing an environment light, and sends the electric signal to the controller 104. The controller 104 includes a judgment unit 1042 and a control unit 1044. After the judgment unit 1042 receives the electric signal sent by the photosensitive sensor 102, the judgment unit processes and matches the signal to determine the operation environment and the operation status of a device, and sending an instruction to the driving chip 106 through the control unit 1044.

The driving chip 106 includes a first driving unit 1062, a second driving unit 1064, a first driving switch 1066 and a second driving switch 1068. With reference to FIG. 3, when a screen cover 3 is opened up, an environment light sensed by the photosensitive sensor 102 is stronger. The judgment unit 1042 determines that the device is under an operation status. The control unit 1044 sends an instruction to the driving chip 106 to turn on the first driving switch 1066 and turn off the second driving switch 1068, and only the first driving unit 1062 is turned on. When the screen cover 3 is closed, the screen cover 3 blocks the photosensitive sensor 102. The environment light sensed by the photosensitive sensor 102 is weaker. The judgment unit 1042 determines that the device is under a standby status. The control unit 1044 sends an instruction to the driving chip 106 in order to turn on the second driving switch 1068 and turn off the first driving switch 1066 such that only the second driving unit 1064 is turned on.

The LED light strip 108 includes multiple backlight lamps 1082 arranged sequentially and adjacently. Wherein, a portion of the LED backlight lamps 1082 are combined into a first window light group 1080. In one embodiment, the first window light group 1080 is located at a terminal of the LED light strip 108. Of course, the first window light group 1080 can also locate at any location of the LED light strip 108. All of the backlight lamps 1082 of the LED light strip 108 are connected with the first driving unit 1062 through a first channel 132. The backlight lamps 1082 of the first window light group 1080 are connected with a second driving unit 1064 through a second channel 134. Each of the first channel 132 and the second channel 134 is a medium formed by conduction line to realize an electric connection between electric devices.

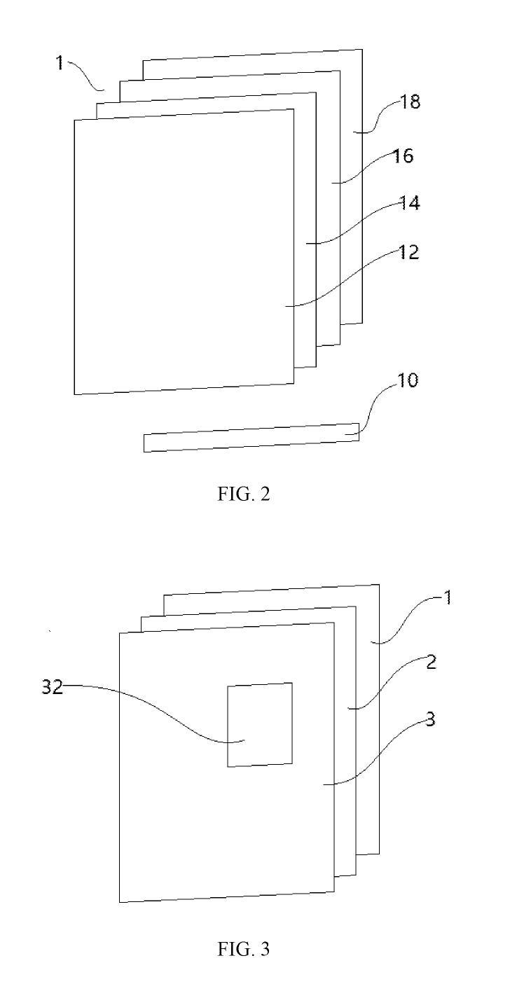

With reference to FIG. 2, if the first driving unit 1062 is turned on, the LED light strip 108 operates and emits light. A light source forms a backlight source 100 after passing through a light guide sheet 16, a reflective sheet 18, a diffusion sheet 14 and a lens sheet 12. The backlight source 100 is a surface light source, and all regions of the backlight source 100 are turned on. If turning on the second driving unit 1064, the first window light group 1080 operates and emits light. A light source only lights up a first cover window display region 110 of the backlight source 100 after passing through the light guide sheet 16, the reflective sheet 18, the diffusion sheet 14 and the lens sheet 12.

The first driving unit 1062 and the second driving unit 1064 respectively control the entire LED light strip 108 and the first window light group 1080 formed by a portion of the backlight lamps 1082 of the LED light strip 108 in order to change light-emitting regions of the backlight source 100. Accordingly to the above design, a display device can judge the operation environment and perform controlling and selecting the light-emitting regions of the backlight source 100 according to an operation requirement. The backlight module 10 can flexibility adapt various operation modes in order to avoid turning on unnecessary portion of the backlight source 100 to save the power consumption and decrease the power consumption of the device.

FIG. 3 is a structural diagram of a display device with cover window provided by the first embodiment of the present invention. The display device with cover window includes a backlight module 1, a display panel 2 and a screen cover 3, wherein, the screen cover 3 is provided with a cover window 32. With also reference to FIG. 1 and FIG. 2, the backlight module 1 determines the operation status of the display device with cover window and drives the backlight module 1 to generate a backlight source 100 according to a display requirement. The backlight source 100 pass through the display panel 2, and displays an image at a display region of the display panel 2. The display device with cover window has two operation statuses. That is, a usage status when opening up the screen cover 3 and a standby status when closing the screen cover 3. When the screen cover 3 is opened up, all regions of the backlight source 100 emit light, and the backlight source 100 passes through the display panel 2 and displays an image on the display panel 2. When the screen cover 3 is closed, the first cover window display region 110 of the backlight source 100 emits light, and the backlight source 100 passes through the display panel 2, and displays an image at a region of the display panel 2 corresponding to the cover window 32. In one embodiment, the backlight control structure 10 is provided with a screen driving chip, and the screen driving chip controls image contents displayed by the display panel 2 when the display device with cover window is under the operation status and the standby status.

The display device with cover window, through opening and closing the screen cover 3 to distinguish the operation status and the standby status of the display device. In the operation status, all screen of the display panel is displayed to meet an usage requirement; in the standby status, the display panel 2 only displays the first cover window display region corresponding to the cover window 32 in order to avoid a redundant power loss, ensure the display effect and decrease the power consumption of the cell phone at the same time.

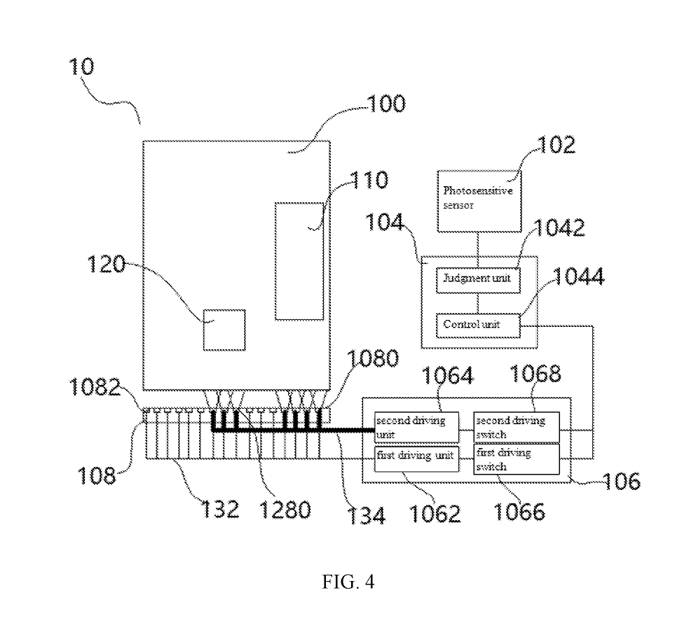

FIG. 4 is a principle diagram of a backlight module provided by the second embodiment of the present invention. As shown in the figure, the difference comparing to the first embodiment is: the backlight source 100 has multiple cover window display regions. In one embodiment, the backlight source 100 has a first cover window display region 110 and a second cover window display region 120. The first cover window display region 110 is lighted up by a light source provided by the first window light group 1080. The second cover window display region 120 is lighted up by a light source provided by a second window light group 1280. The first window light group 1080 and the second window light group 1280 are both controlled by the second driving unit 1064 and turning on and off simultaneously. In one embodiment, the first window light group 1080 and the second window light group 1280 have different backlight lamps 1082, and locations of the first window light group 1080 and the second window light group 1280 are not adjacent such that locations of the first cover window display region 110 and the second cover window region 120 are not overlapped and not adjacent. Of course, the locations of the first cover window display region 110 and the second cover window region 120 can be overlapped and adjacent.

The backlight module 1 provided by the present invention also has advantages of adapting for various operation environments and saving power consumption. At the same time, the display panel 2 of the backlight module 1 provided by the present invention can be more flexible to display more rich image, decrease the power consumption and providing better user experience.

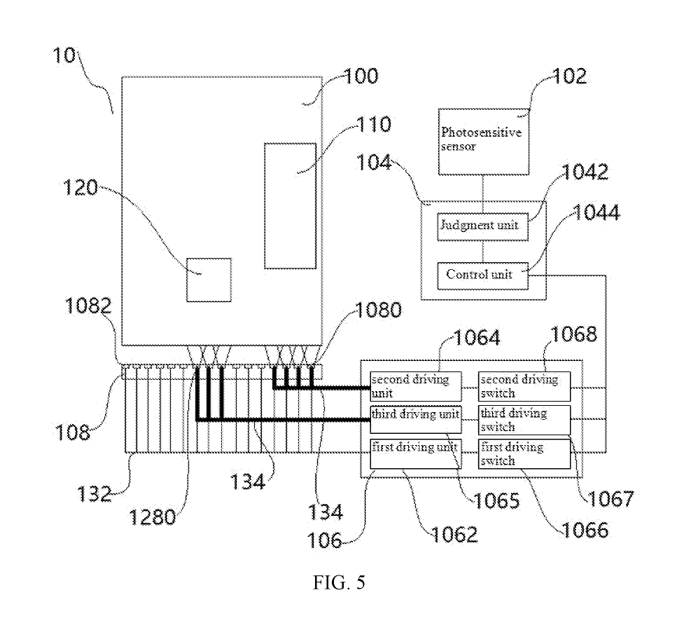

FIG. 5 is a principle diagram of a backlight module provided by a third embodiment of the present invention. As shown in the figure, the difference comparing to the second embodiment is: each window light group is controlled by one corresponding driving unit to control individually. In one embodiment, the driving chip 106 includes a second driving unit 1064 and a third driving unit 1065, the LED light strip 108 includes a first window light group 1080 and a second window light group 1280. The second driving unit 1064 individually controls the first window light group 1080, the third driving unit 1065 individually controls the second window light group 1280. The first window light group 1080 and the second window light group 1280 can be individually turned on or off. That is, the first cover window display region 110 and the second cover window display region 120 can be individually lighted up.

The backlight module provided by the third embodiment can have higher flexibility and increase the display effect and decrease the power consumption at the same time comparing to the second embodiment.

The above embodiment does not constitute a limitation of the scope of protection of the present technology solution. Any modifications, equivalent replacements and improvements based on the spirit and principles of the above embodiments should also be included in the protection scope of the present technology solution.

What is claimed is:

1. A backlight control structure, comprising a sensor, a controller, a driving chip and a light strip which are electrically connected sequentially, wherein, the driving chip includes a first driving unit and a second driving unit; the light strip includes multiple backlight lamps, and a portion of the backlight lamps which are sequentially adjacent forms a first window light group for lighting up a first cover window display region of a display device; the photosensitive sensor senses a change of an operation environment and sends an electric signal to the controller; after the controller processes the received electric signal, the controller selectively controls operation statuses of the first driving unit and the second driving unit; the first driving unit drives all of the backlight lamps of the light strip to emit light, and the second driving unit drives the first window light group to emit light.

2. The backlight control structure according to claim 1, wherein, the driving chip includes a first driving switch and a second driving switch; the first driving switch is connected between the controller and the first driving unit; the second driving switch is connected between the controller and the second driving unit.

3. The backlight control structure according to claim 2, wherein, the controller includes a judgment unit and a control unit; the judgment unit receives the electric signal sent by the photosensitive sensor and determines an operation status of the display device; the control unit turns on or off the first driving switch or the second driving switch according to a processing result of the judgment unit.

4. The backlight control structure according to claim 1, wherein, the light strip further includes a second window light group formed by a portion of the backlight lamps for lighting up a second cover window display region of the display device, the second driving unit simultaneously controls the first window light group and the second window light group.

5. The backlight control structure according to claim 1, wherein, the light strip further includes a second window light group formed by a portion of the backlight lamps for lighting up a second cover window display region of the display device; the driving chip includes a third driving unit for controlling the second window light group; the first window light group and the second window light group operate independently.

6. The backlight control structure according to claim 1, wherein, the sensor is a photosensitive sensor.

7. The backlight control structure according to claim 1, wherein, the first window light group is located at a terminal of the light strip.

8. The backlight control structure according to claim 1, wherein, the controller adopts a 16-bit micro control unit.

9. A display device with cover window, comprising a screen cover, a display panel and a backlight module; the backlight module includes a lens sheet, a diffusion sheet, a light guide sheet, a reflective sheet and a backlight control structure; a light source generated by backlight lamps forms a backlight source after passing through the light guide sheet, the reflective sheet, the diffusion sheet and the lens sheet; the screen cover includes a transparent cover window; when the screen cover of a display device with cover window is opened up, all display regions of the display panel display an image; when the screen cover of display device with cover window is closed, a cover window display region of the display panel corresponding to the transparent cover window displays an image.

10. The display device with cover window according to claim 9, wherein, the backlight control structure comprises a sensor, a controller, a driving chip and a light strip which are electrically connected sequentially, wherein, the driving chip includes a first driving unit and a second driving unit; the light strip includes multiple backlight lamps, and a portion of the backlight lamps which are sequentially adjacent forms a first window light group for lighting up a first cover window display region of a display device; the photosensitive sensor senses a change of an operation environment and sends an electric signal to the controller; after the controller processes the received electric signal, the controller selectively controls operation statuses of the first driving unit and the second driving unit; the first driving unit drives all of the backlight lamps of the light strip to emit light, and the second driving unit drives the first window light group to emit light.

11. The display device with cover window according to claim 10, wherein, the driving chip includes a first driving switch and a second driving switch; the first driving switch is connected between the controller and the first driving unit; the second driving switch is connected between the controller and the second driving unit.

12. The display device with cover window according to claim 11, wherein, the controller includes a judgment unit and a control unit; the judgment unit receives the electric signal sent by the photosensitive sensor and determines an operation status of the display device; the control unit turns on or off the first driving switch or the second driving switch according to a processing result of the judgment unit.

13. The display device with cover window according to claim 10, wherein, the light strip further includes a second window light group formed by a portion of the backlight lamps for lighting up a second cover window display region of the display device, the second driving unit simultaneously controls the first window light group and the second window light group.

14. The display device with cover window according to claim 10, wherein, the light strip further includes a second window light group formed by a portion of the backlight lamps for lighting up a second cover window display region of the display device; the driving chip includes a third driving unit for controlling the second window light group; the first window light group and the second window light group operate independently.

15. The display device with cover window according to claim 10, wherein, the sensor is a photosensitive sensor.

16. The display device with cover window according to claim 10, wherein, the first window light group is located at a terminal of the light strip.

17. The display device with cover window according to claim 10, wherein, the controller adopts a 16-bit micro control unit.

18. The display device with cover window according to claim 9, wherein, the backlight control structure is provided with a screen driving chip, and the screen driving chip controls image contents displayed by the display panel respectively when the screen cover is opened up and the screen cover is closed.
